(19) United States
(12) Patent Application Publication
(10) Pub. No.: US 2011/0023372 A1
(43) Pub. Date: Feb. 3, 2011

(54) EXTRUSION MOLDED PRODUCT HAVING CORE MATERIAL

(76) Inventors: Naohisa MIYAKAWA, Shiroi-shi (JP); Katsuhisa Kato, Inzai-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/845,032

(22) Filed: Jul. 28, 2010

(30) Foreign Application Priority Data
Jul. 28, 2009 (JP) 2009-189551

(51) Int. Cl. E06B 7/16

(52) U.S. Cl. 49/490.1

(57) ABSTRACT

An extrusion molded product having a core material, such as a weather strip and a trim, for mounting thereof on a flange around the periphery of an opening of an automobile body, such as a door, a trunk, and a back door comprises a molded product body (1) which includes a core material (3) having a generally U-shaped cross section in a longitudinal direction, a coating layer (2) having holding portions (4) formed inside side portions of the core material (3), and a contact layer (6) consisting of a thermoplastic elastomer composition harder than the holding portions (4) and formed integrally with the holding portions (4) on a surface abutting the flange (5).

### BACKGROUND OF THE INVENTION

1. Field of the Invention

The present invention relates to an extrusion molded product having a core material, such as a weather strip and a trim, for mounding thereof on a flange around the periphery of an opening of an automobile, such a door, a trunk, and a back door.

2. Description of the Related Art

In a conventional extrusion molded product having a core material for mounding thereof on a flange around the periphery of an opening of an automobile body, such as a door, a trunk, and a back door, a molded product body 1 comprises a core material 3 having a generally U-shaped cross section in the longitudinal direction and a coating layer 2 having protruding holding portion 4 formed inside side portion 7 of the core material 3, as shown in FIG. 7. The molded product body 1 is mounted on a flange 5, as shown in FIG. 8, and the holding portion 4 abuts and holds the flange 5.

When the material of the holding portion according to the example disclosed in the Japanese Patent Application No. 2006-44341 is formed of a soft thermoplastic elastomer having a Shore hardness A of 20 to 50, the holding portion is soft, because of a soft material, and the force of holding the flange decreases. Therefore, a problem arises that the molded product body falls off the flange.

Further, in order to solve the above problem, the material of the holding portion has been formed of a thermoplastic elastomer having type A durometer (Shore A) hardness of 50 or more. However, when the hardness of the material is 85 or more, the insertion force when the molded product body is attached to the flange increases, and the attachment workability is worse.

### SUMMARY OF THE INVENTION

It is an object of the present invention to provide an extrusion molded product having a core material which can firmly hold a flange around the periphery of an opening of an automobile body.

It is another object of the present invention to provide an extrusion molded product having a core material which can be easily and surely attached to a flange around the periphery of an opening of au automobile body.

In an extrusion molded product having a core material according to the present invention, a molded product body comprises a core material having a generally U-shaped cross section in the longitudinal direction and a coating layer having protruding holding portions formed inside side portion of the core material, and a contact layer is formed on at least part of the holding portion on a surface abutting the flange, thus solving the problem that the molded product body falls a flange.

The thermoplastic elastomer composition of the contact layer comprises

100 parts by weight of a thermoplastic resin composition (A) comprising:

30 to 70 parts by weight of component (a): polyethylene polymerized with a single-site catalyst, or a copolymer mainly consisting of the polyethylene;

5 to 25 parts by weight of component (b): a block copolymer comprising at least two polymer blocks A mainly consisting of a vinyl aromatic compound and at least one polymer block B mainly consisting of a conjugated diene compound, and/or a hydrogenated block copolymer obtained by hydrogenating the block copolymer;

10 to 30 parts by weight of component (c): a homopolymer of crystalline ethylene or propylene, or a crystalline copolymer mainly consisting of the ethylene or propylene; and

5 to 25 parts by weight of component (d): a rubber softener; and compounds the following component to 100 parts by weight of said thermoplastic resin composition (A);

2 to 8 parts by weight of component (e): a petroleum resin and/or a hydrogenated petroleum resin obtained by hydrogenation.

Further, the thermoplastic elastomer composition of the contact layer described above comprises further 1 to 20 parts by weight of component (f): an inorganic filler in addition to 100 parts by weight of the thermoplastic resin composition (A).

Also, the thermoplastic elastomer composition of the contact layer is formed on part of the holding portion. Therefore, the holding portion bents easily from the portion of the contact layer, decreasing the insertion force. Further, the contact area between the contact layer and the flange increases, achieving the effect of increasing the holding force.

Further, the contact layer is formed of a tacky thermoplastic elastomer composition, and the contact layer sticks to a surface of the flange. Therefore the molded product body does not easily slip off the flange, further solving the problem of falling off.

### BRIEF DESCRIPTION OF THE DRAWING

FIG. 1 is a longitudinal sectional view of a molded product body having a core material according to the present invention;

FIG. 2 is a longitudinal sectional view showing a state in which the molded product body of the present invention is mounted on a flange around the periphery of an opening of an automobile body;

FIG. 3 is a longitudinal sectional view in which the molded product body of the present invention has protruding holding portions formed inside side portions of the core material;

FIG. 4 is a longitudinal sectional view showing another embodiment of the present invention;

FIG. 5 is a side view showing a method for manufacturing an extrusion molded product having a core material of the present invention;

FIG. 6 is a perspective view in which cut-out portions are formed in the side portions of the core material of the present invention;

FIG. 7 is a longitudinal sectional view showing a conventional molded product body; and

FIG. 8 is a longitudinal sectional view showing a state in which a conventional molded product body is mounted on a flange.

### DETAILED DESCRIPTION OF THE PREFERRED EMBODIMENTS

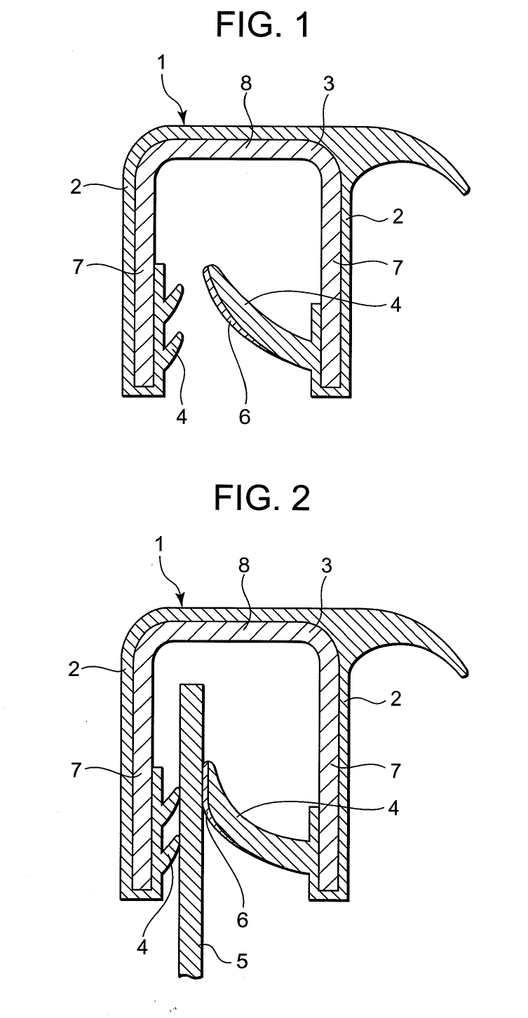

The embodiments of the present invention will be described with reference to the drawings. FIG. 1 shows a cross section of an extrusion molded product having a core material, such as a weather strip and trim, for mounting thereof on a flange 5 around the periphery of an opening of an automobile body, such as a door, a trunk, and a back door. A molded product body 1 comprises a core material 3 made of a synthetic resin or a metal and having a generally U-shaped cross section in the longitudinal direction, and a coating layer 2 consisting of a thermoplastic elastomer. or foam thereof. The coating layer 2 has protruding holding portions 4 of a thermoplastic elastomer or foam thereof formed inside side portions 7 of the core material 3. A contact layer 6 is formed on part of the holding portions 4 on one side on a surface abutting the flange 5. Preferably, the contact layer 6 is formed on part of the tip side of the holding portion 4.

The contact layer 6 comprises a thermoplastic elastomer composition harder than the holding portion 4, and the contact layer 6 comprises a tacky thermoplastic elastomer composition. Further, the coating layer 2 is formed on part or all of periphery of the core material 3, as required.

FIG. 2 shows a state in which the molded product body 1 in FIG. 1 is mounted on the flange 5 around the periphery of the opening of the body.

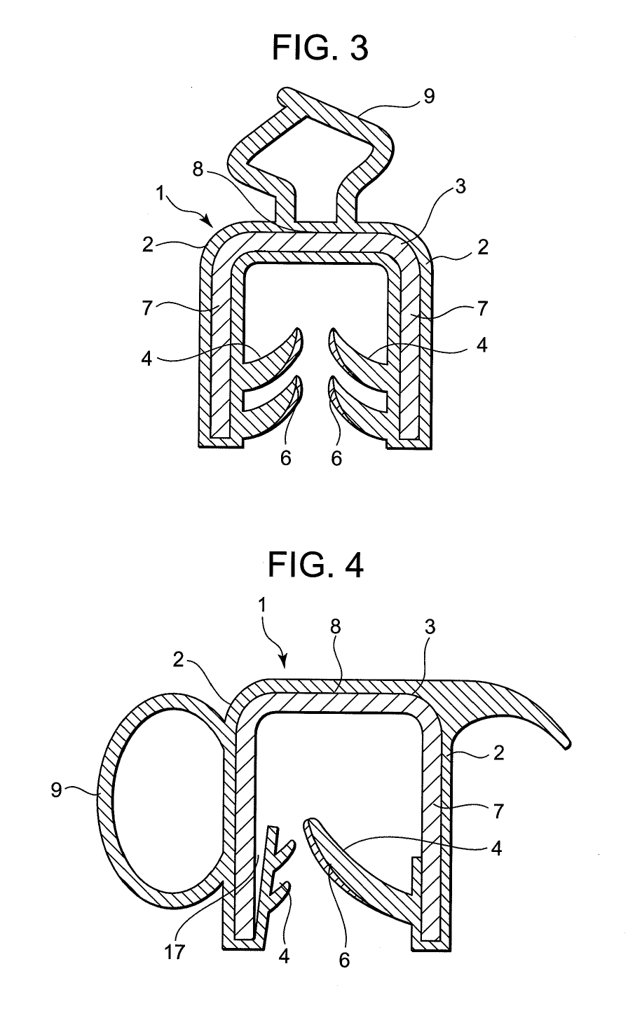

In FIG. 3, the coating layer 2 has protruding holding portion 4 formed inside the side portions 7 of the core material 3, and the contact layers 6 are formed on the holding portions 4 on both opposed sides on surfaces abutting the flange 5.

Also, the core material 3 and the coating layer 2 are heat-welded. But, there is also a case where heat welding is not performed in part, only to form a non-welded portion 17, as shown in FIG. 4.

Further, a hollow seal portion 9 is formed in various types of shapes, such as a polygonal shape, a circular shape, and an elliptical shape, as required, and is formed at the desired position outside a connecting portion 8 or side portions 7 of the core material 3.

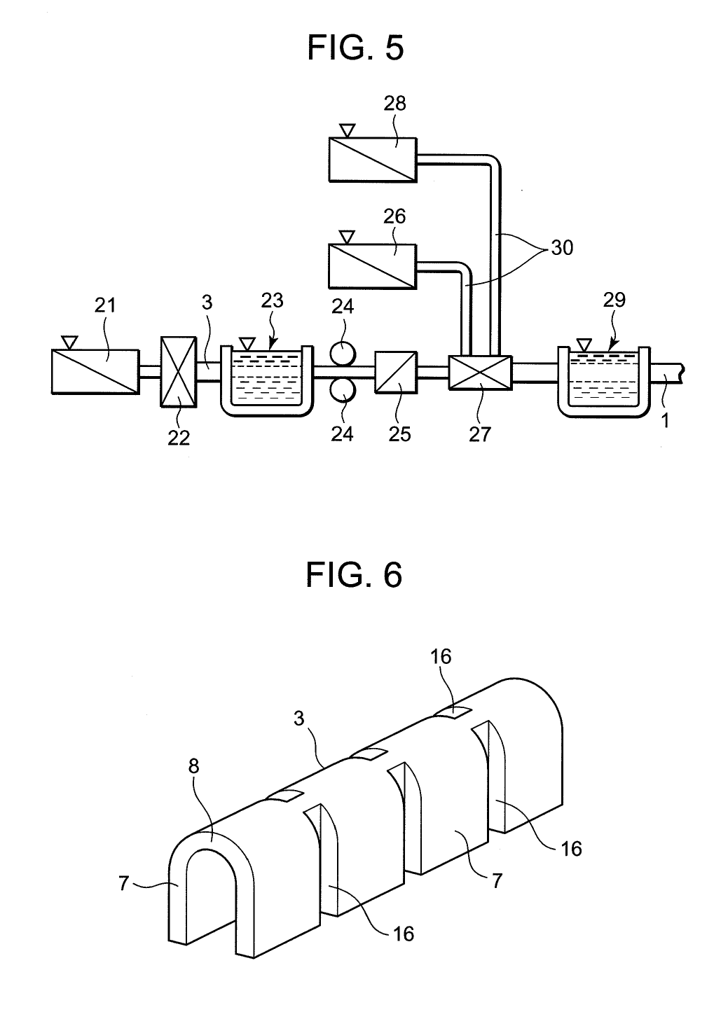

FIG. 5 shows an embodiment of a method for manufacturing the molded product body 1 of the extrusion molded product having the core material, which is continuously manufactured from the core material 3 comprising a synthetic resin. A hard synthetic resin is injected into a first extrusion molding machine 21, and the core material 3 having a generally U-shaped cross section is formed through a first mold die 22. Then, the core material 3 passes through a first cooling tank 23 and then a take-up roller 24, and cut-out portions 16 are cut out, in desire various shapes, in the side portions 7 and connecting portion 8 of the core material 3 having a generally U-shaped cross section by a cutting machine 25, as shown in FIG. 6.

Then, the core material enters inside a second mold die 27, and a melted thermoplastic elastomer forming the coating layer 2 and holding portion 4 injected in a second extrusion molding machine 26, and a melted thermoplastic elastomer composition forming the contact layer 6 injected in a third extrusion molding machine 28 pass through injection tubes 30 and are heat-welded to the periphery of the core material inside the second mold die 27. Subsequently, the core material 3 having the coating layer 2, the holding portion 4 and the contact layer 6 heat-welded to each another pass through a second cooling tank 29.

When the hollow seal portion 9 is formed, an extrusion molding machine is further added, and a material forming the hollow seal portion 9 is heat-welded to the periphery of the core material 3 and the coating layer 2 inside the second mold die 27.

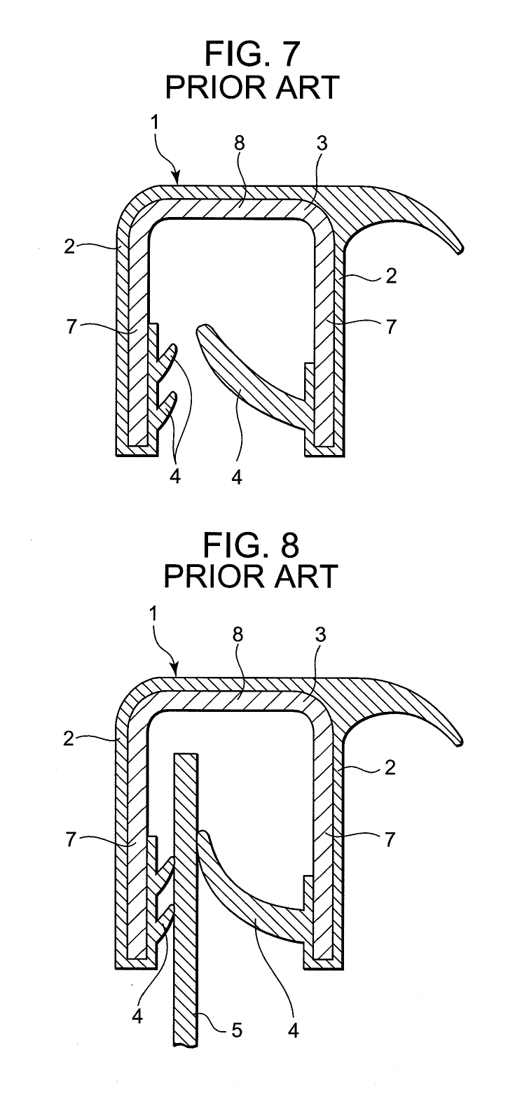

FIG. 7 shows an embodiment of a conventional molded product. FIG. 8 shows a state in which the conventional molded product is mounted on the flange 5. Due to lack of the contact portion 6, the holding portion 4 bends gently, and therefore, the contact area between the holding portion and the flange is small.

The thermoplastic elastomer composition forming the contact layer 6 will be described.

### Component (a): Essential Component

One or two or more selected preferably from polyethylenes polymerized with a single-site catalyst, preferably polyethylenes, such as high density polyethylene (low pressure polyethylene), low density polyethylene (high pressure polyethylene), and linear low density polyethylene (copolymer of ethylene and a small amount, preferably 1 to 10 mole %, of α-olefin, such as butene-1, hexene-1, and octene-1), all polymerized with a single-site catalyst (metallocene catalyst); and ethylene-propylene copolymer, ethylene-vinyl acetate copolymer and the like, are preferably used as a polyethylene polymerized with a single-site catalyst, or a copolymer mainly comprising the polyethylene.

Ethylene-octene copolymers having a specific gravity of 0.92 or less and a melting point of 95° C. or less and manufactured using a metallocene catalyst (single-site catalyst) are preferred. Those copolymers having a melt flow rate (MFR) of 0.5 g/10 min. or more at a temperature of 190° C. and under a load of 2.16 kg are generally favorable. One or more of those may be combined.

### Component (b): Essential Component

A component (b) is a block copolymer comprising at least two polymer blocks A mainly consisting of a vinyl aromatic compound and at least one polymer block B mainly consisting of a conjugated diene compound, or product obtained by hydrogenating the block copolymer, or mixture thereof. Examples thereof can include vinyl aromatic compound-conjugated diene compound block copolymers having structures, such as A-B-A, B-A-B-A, and A-B-A-B-A, and/or hydrogenated products thereof.

The above (hydrogenated) block copolymer (here, (a hydrogenated) block copolymer means a block copolymer and/or a hydrogenated block copolymer) comprises 5 to 60% by weight, preferably, 20 to 50% by weight, of a vinyl aromatic compound.

Preferably, the polymer block A mainly comprising of a vinyl aromatic compound is consisted of only a vinyl aromatic compound, or is a copolymer block of 50% by weight or more, preferably 70% by weight or more, of a vinyl aromatic compound, and a conjugated diene compound, or a hydrogenated product thereof.

Preferably, the polymer block B mainly consisting of a conjugated diene compound comprises only a conjugated diene compound, or is a copolymer block of 50% by weight or more, preferably 70% by weight or more, of a conjugated diene compound, and a vinyl aromatic compound, or hydrogenated product thereof.

In each of the polymer block A mainly comprising a vinyl aromatic compound, and the polymer block B mainly comprising a conjugated diene compound, the distribution of the vinyl compound or the conjugated diene compound in the molecular chain may be random, tapered (the monomer component increases or decreases along the molecular chain), partially blocked, or in any combination thereof.

When there are two or more polymer blocks A mainly comprising a vinyl aromatic compound, or two or more polymer blocks B mainly comprising a conjugated diene compound, each may have the same structure or a different structure.

As the vinyl aromatic compound constituting the (hydrogenated) block copolymer, one or two or more can be selected, for example, from styrene, α-methyl styrene, vinyl toluene, p-terti-butyl styrene, and the like. Among them, styrene is preferred. As the conjugated diene compound, one or two or more are selected, for example, from butadiene, isoprene, 1,3-pentadiene, 2,3-dimethyl-1,3-butadiene, and the like. Among them, butadiene, isoprene, and combination thereof are preferred.

The micro-bond in the polymer block B mainly comprising a conjugated diene compound can be arbitrarily selected.

In a butadiene block, preferably, the 1,2-micro-bond accounts for 20 to 50%, particularly 25 to 45%.

In a polyisoprene block, preferably, 70 to 100% by weight of the isoprene compound has a 1,4-micro-bond, and at least 90% or more of aliphatic double bonds based on the isoprene compound are hydrogenated.

For the weight average molecular weight of the (hydrogenated) block copolymer having the above structure used in the present invention, the lower limit value is in the range of 5,000 or more, preferably 10,000 or more, and more preferably 80,000 or more, and the upper limit value is in the range of 400,000 or less, preferably 300,000 or less and more preferably 150,000 or less. The molecular weight distribution (the ratio of the weight average molecular weight (Mw) to the number average molecular weight (Mn) (Mw/Mn) is preferably 10 or less, further preferably 5 or less, and more preferably 2 or less. The molecular structure of the (hydrogenated) block copolymer may be any of linear, branched, radial or any combination thereof.

### Component (c): Essential Component

The component (c) used in the present invention includes a homopolymer of crystalline ethylene or propylene, or a crystalline copolymer mainly comprising the ethylene or propylene. They include crystalline ethylene polymers, such as high density polyethylene, low density polyethylene, and ethylene-butene-1 copolymer, and crystalline propylene polymers, such as isotactic polypropylene, propylene-ethylene copolymer, propylene-butene-1 copolymer, and propylene-ethylene-butgene-1 ternary copolymer. Among them, polypropylene resins are preferred.

### Component (d): Essential Component

A rubber softener component (d) used in the present invention may be a non-aromatic rubber softener component or an aromatic rubber softener component or an aromatic rubber softener component, and an ester plasticizer can also be used. But, particularly, non-aromatic mineral oil and an ester plasticizer are preferred. Examples of the non-aromatic mineral oil softener include a paraffin softener in which the number of paraffin chain carbons accounts for 50% or more of the total number of carbons.

### Component (e): Essential Component

A petroleum resin component (e) used in the present invention is a resin obtained by copolymerizing, as a raw material, unsaturated hydrocarbon obtained in various processes, particularly a naphtha decomposition process, in the petroleum refining industry and the petrochemical industry. Examples thereof can include aliphatic petroleum resins comprising C5 fractions as a raw material, aromatic petroleum resins comprising C9 fractions as a raw material, alicyclic petroleum resins comprising dicyclopentadiene as a raw material, and terpene resins, and copolymerized petroleum resins obtained by copolymerizing two or more thereof, and further, hydrogenated petroleum resins obtained by hydrogenating these, and the like. The hydrogenated petroleum resins of the above resins are obtained by hydrogenating the above resins by methods known to those skilled in the art. Specifically, commercial products, such as I-MARV (a hydrogenated petroleum resin) manufactured by Idemitsu Kosan Co., Ltd., ARKON (a hydrogenated petroleum resin) manufactured by Arakawa Chemical Industries, Ltd., CLEARON (a hydrogenated terpene resin) manufactured by Yasuhara Chemical Co., Ltd., and ESCOREZ (an aliphatic hydrocarbon resin) manufactured by Tornex Co., Ltd., can be used.

A thermoplastic resin composition (A) is composed of the components (a), (b), (c), and (d). For the contents of the components, (a) is 30 to 70 parts by weight, (b) is in 5 to 25 parts by weight, (c) is in 10 to 30 parts by weight, and (d) is in 5 to 25 parts by weight. Preferably, (a) is in 40 to 60 parts by weight, (b) is in 10 to 20 parts by weight, (c) is in 15 to 25 parts by weight, and (d) is in 10 to 20 parts by weight.

The content of the component (e) is preferably 2 to 8 parts by weight with respect to 100 parts by weight of the thermoplastic resin composition (A).

### (f) Inorganic Filler

An inorganic filler component (f) can be compounded in the thermoplastic elastomer composition of the present invention, as required. The component (f) has the effect of improving some properties, such as compressive permanent strain, of the molded product obtained from the thermoplastic elastomer composition, as well as an economical advantage due to an increase in amount. Examples of the component (f) include wallastonite, chlorite, calcium carbonate, talc, silica, diatomaceous earth, barium sulfate, magnesium carbonate, magnesium hydroxide, mica, clay, titanium oxide, carbon black, glass fiber, hollow glass balloons, carbon fiber, calcium titanate fiber, natural slicic acid, synthetic slicic acid (white carbon), and the like. Among these, calcium carbonate, wallastonite, chlorite, and talc are particularly preferred.

The content of the component (f) is preferably 1 to 20 parts by weight with respect to 100 parts by weight of the thermoplastic resin composition (A).

A usage example of the hardness of the materials of the molded product body 1 used in the present invention will be described. But, the hardness is not limited to this. The core material 3 having a generally U-shaped cross section comprises a hard synthetic resin. An olefinic resin of a mixed synthetic resin obtained by mixing an olefinic resin with 20 to 50% by weight of powder such as talc, having a type A durometer hardness (JIS K6253, value after 15 seconds) of 90 or more, is used as the hard synthetic resin to increase rigidity and decrease the coefficient of linear expansion.

Further, an olefinic thermoplastic elastomer, a styrenic thermoplastic elastomer, or their foams having a type A durometer hardness (JIS K6253, a value after 15 seconds) of 50 to 80 is used as the thermoplastic elastomer or foam thereof forming the coating layer 2 and the holding portion 4.

Also, a thermoplastic elastomer composition having a type A durometer hardness (JIS K6253, a value after 15 seconds) of 60 to 90 is used as the material of the thermoplastic elastomer composition forming the contact layer 6.

Further, a type A durometer hardness (JIS K6253, a value after 15 seconds) of 20 to 50 is used for the thermoplastic elastomer or foam thereof forming the hollow seal portion 9.

### EXAMPLES

Examples of the thermoplastic elastomer composition forming the contact layer 6 of the present invention (hereinafter simply referred to as a material. A) will be described. But, the present invention is not limited to these. The materials and test methods used in the Examples are as follows.

### Material A

### (a) Component

50 parts by weight of a metallocene catalyzed ethylene-1-exene copolymer having a density of 0.88 g/cm3 and a MFR (190° C., 21.18 N) of 2.2 g/10 min., trade name: KS240, manufactured by Japan Polyethylene Corporation

### (b) Component

15 parts by weight of a styrene-isoprene block copolymer having a styrene content of 30% by weight, an isoprene content of 70% by weight, a weight average molecular weight of 260,000, and a molecular weight distribution of 1.3, and with 90% or more hydrogenation, trade name: SEPTON 4055, manufactured by Kuraray Co., Ltd.

### (c) Component

20 part by weight of a polypropylene random copolymer having a MFR (230° C., 21.18 N) of 7 g/10 min., trade name: FW4BT, manufactured by Japan Polypropylene Corporation

### (d) Component

15 parts by weight of a non-aromatic hydrocarbon rubber softener (paraffin oil) having a weight average molecular weight of 540, trade name: Diana Process Oil PW-90, manufacture by Idemitsu Kosan Co., Ltd. ((a)+(b)+(c)+(d)=100 parts by weight)

### (e) Component

5 parts by weight of a petroleum resin having a softening point of 140° C., an average molecular weight of 910, and a density of 1.03, trade name: I-MARV P-140, manufactured by Idemitsu Kosan Co., Ltd.

### (f) Component

10 parts by weight of calcium carbonate (CaCO3) NS400, manufactured by Sankyo Seifun Co., Ltd.
A pellet-like material obtained by compounding, and melting and kneading the above components was used.

The following test methods were performed, and the values of properties in Table were obtained.

### 1. Hardness:

According to JIS K6253, using a 6.3 mm thick press sheet as a test piece, the type A durometer hardness was measured, and the value after 15 seconds was obtained. The measurement temperature was 23° C.

### 2. Tensile Strength, 100% Modulus, and Elongation:

The measurement of tensile strength, 100% modulus, and elongation conformed to JIS K6301. For the test piece, a 2 mm thick press sheet was punched in a No. 3 dumbbell shape for use. The tensile speed was 500 mm/min. The measurement temperature was 23° C.

### 3. Permanent Elongation:

The measurement of permanent elongation conformed to JIS K6273. For the test piece, using a 2 mm thick press sheet, a strip shape with a width of 6 mm was used.

For the measurement condition and pretreatment, the sample was left under load with an elongation percentage of 100% for a test time of 24 hours. Then, the permanent elongation of the sample was measured. The distance between gages was 50 mm, and the tensile speed was 10 mm/min.

TABLE 1

| | Material A |
|---|---|
| Hardness | 83 |
| Tensile strength | 14.2 |
| 100% modulus | 4.2 |
| Elongation | 750 |
| Permanent elongation | 33 |

Next, a thermoplastic elastomer having the values of properties of a type A duromer hardness (JIS K6253, a value after 15 seconds), of 72, a tensile strength of 10 MPa (JIS K6251), a 100% modulus of 3.1 MPa (JIS K6251), 600% elongation (JIS K6251), and 21% permanent elongation (JIS K6273) was used as the thermoplastic elastomer used for the holding portion 4 (hereinafter simply referred to as a material B)

Then, in Example 1, the molded product body 1 in which the contact layer 6 comprising the material A was formed on the holding portion 4 comprising the material B was extrusion molded. The molded product body 1 was mounted on the flange 5, as shown in FIG. 2, and the holding force and the insertion force were measured and are shown in Table 2.

In comparative Example 1, the molded product body 1 only with the holding portion 4 comprising the material B, in which the contact layer 6 was not formed, was extrusion molded. The molded product body 1 was mounted on the flange 5, as shown in FIG. 8, and the holding force and the insertion force were measured and are shown in Table 2.

As is also clear from Table 2, it is seen that Example 1 in which the contact layer 6 is formed has a small insertion force and therefore has excellent attachment workability, and that Example 1 has a large holding force and therefore solves the problem that the molded product body 1 falls off the flange.

Further, a mark O of Evaluation in Table 2 interprets good, and a mark X interprets bad.

TABLE 2

| | | | Holding | Insertion | |
|---|---|---|---|---|---|
| | Constitution | | Force | Force (N/ | |
| | Material | | (N/100 mm) | 100/mm) | Evaluation |
| Example 1 | Holding | Material B | 89 | 38 | ◯ |
| | portion | | | | |
| | With | Material A | | | |
| | contact | | | | |
| | layer | | | | |
| Comparative | Holding | Material B | 60 | 44 | X |
| Example 1 | portion | | | | |
| | Without | | | | |
| | contact | | | | |
| | layer | | | | |

The present invention is constituted as described above. Therefore, the molded product body 1 comprises the core material 3 having a generally U-shaped cross section in the longitudinal direction and the coating layer 2 having the protruding holding portion 4 formed inside side portion 7 of the core material 3, and the contact layer 6 is formed on the holding portion 4 on a surface abutting the flange 5, thus solving the problem that the molded product body 1 falls off the flange 5. The thermoplastic elastomer composition of the contact layer 6 is formed on part of the holding portion 4. Therefore, the holding portion bends easily from the portion of the contact layer 6, decreasing the force of inserting the holding portion 4, and providing excellent workability. Also, the holding force is increased, further solving the problem that the molded product body 1 falls off the flange 5.

Also, the contact layer 6 is made of a hard material. Therefore, the insertion force decreases. Further, the contact area between the contact layer 6 and the flange 5 increases, achieving the effect of increasing the holding force.

Moreover, the contact layer 6 is formed of a tacky thermoplastic elastomer composition, and the contact layer 6 sticks to a surface of the flange 5. Therefore, the molded product body 1 does not easily slip off the flange 5, increasing the holding force to achieve the effect of the properties for further solving the problem that the molded product body 1 falls off.

1. An extrusion molded product having a core material for mounting thereof on a flange around the periphery of an opening of an automobile body, wherein a molded product body comprises a core material having a generally U-shaped cross section in a longitudinal direction, a coating layer having holding portions formed inside side portion of the core material, and a contact layer consisting of a thermoplastic elastomer composition and formed integrally with the holding portion on a surface abutting the flange.

2. The extrusion molded product having a core material according to claim 1, wherein the thermoplastic elastomer composition of the contact layer comprises:
100 parts by weight of a thermoplastic resin composition (A) including:
30 to 70 parts weight of component (a): polyethylene polymerized with a single-site catalyst, or a copolymer mainly consisting of the polyethylene;
5 to 25 parts by weight of component (b): a block copolymer comprising at least two polymer blocks A mainly consisting of a vinyl aromatic compound and at least one polymer block B mainly consisting of a conjugated diene compound, and/or a hydrogenated block copolymer obtained by hydrogenating the block copolymer;
10 to 30 parts by weight of component (c): a homopolymer of crystalline ethylene or propylene, or a crystalline copolymer mainly consisting of the ethylene or propylene; and
5 to 25 parts by weight of component (d): a rubber softener; and compounds the following component to 100 parts by weight of the thermoplastic resin composition (A);
2 to 8 parts by weight of component (e): a petroleum resin and/or a hydrogenated petroleum resin obtained by hydrogenation.

3. The extrusion molded product having a core material according to claim 2, wherein the thermoplastic elastomer composition of the contact layer further comprises 1 to 20 parts by weight component (f); an inorganic filler in addition to 100 parts by weight of the thermoplastic resin composition (A).

4. The extrusion molded product having a core material according to claim 1, wherein the contact layer is formed on part of the holding portion.

5. The extrusion molded product having a core material according to claim 1, wherein the contact layer is formed on the holding portion only on the one side portion.

6. The extrusion molded product having a core material according to claim 1, wherein the contact layer is formed on the holding portion on both side portions.

7. The extrusion molded product having a core material according to claim 1, wherein the contact layer comprises a thermoplastic elastomer composition harder than the holding portions.

8. The extrusion molded product having a core material according to claim 1, wherein the contact layer comprises a tacky thermoplastic elastomer composition.
